(19) United States
(12) Patent Application Publication
(10) Pub. No.: US 2014/0063285 A1
(43) Pub. Date: Mar. 6, 2014

(54) IMAGE DATA PROCESSING APPARATUS, IMAGING APPARATUS, AND IMAGE DATA PROCESSING METHOD

(71) Applicant: Sony Corporation, Tokyo (JP)

(72) Inventors: Kei Kakidani, Kanagawa (JP); Kazuhiro Sugeno, Kanagawa (JP); Nobuo Ohishi, Shizuoka (JP)

(73) Assignee: Sony Corporation, Tokyo (JP)

(21) Appl. No.: 13/973,085

(22) Filed: Aug. 22, 2013

(30) Foreign Application Priority Data
Aug. 28, 2012 (JP) 2012-187409

(51) Int. Cl. H04N 5/235

(52) U.S. Cl. CPC H04N 5/2357
USPC 348/226.1

(57) ABSTRACT

Disclosed is an image data processing apparatus including a brightness detection part, a moving average calculation part, a change quantity detection part, a false correction determination part, and a correction part. The brightness detection part detects brightness of pixels in a prescribed range of each frame from image data acquired from an imaging device. The moving average calculation part calculates a moving average of prescribed cycles of the brightness to calculate a temporal average brightness value. The change quantity detection part detects a change quantity of an inclination of a waveform constituted of the temporal average brightness value. The false correction determination part determines a likelihood of false correction to the image data based on information representing a change of the inclination. The correction part corrects the image data acquired from the imaging device based on the determination result of the false correction determination part.

### BACKGROUND

The present disclosure relates to an image data processing apparatus, an imaging apparatus, and an image data processing method, and in particular, to a technology for reducing flicker.

In some cases, flicker causing a state in which shooting images appear to blink occurs when moving images are shot under illumination light such as fluorescent light whose brightness changes depending on power-supply frequencies. The occurrence of flicker is caused by the difference between the fluctuation cycle of the brightness of illumination light and the cycle of imaging (hereinafter referred also to as an “imaging cycle”). It has been known that “in-screen flicker” (referred also to as “line flicker”) causing a state in which lines appear to blink occurs when rolling shutter type sensors such as CMOS (Complementary Metal Oxide Semiconductor) image sensors are used as imaging devices. In addition, it has been known that screen flicker causing a state in which the whole screen blinks occurs when global shutter type sensors such as CCD (Charge Coupled Device) image sensors are used as imaging devices. In particular, the blinking becomes noticeable when overcrank shooting in which the number of frames per second increases is performed.

Screen flicker occurs when the blinking cycle of illumination light is not equal to the integral multiple of an imaging cycle. The blinking cycle of illumination light depends on a power-supply frequency, and 50 Hz or 60 Hz is used as the power-supply frequency worldwide. For example, the power-supply frequency is set at 60 Hz in western Japan, and illumination light has a blinking cycle of 1/120 second in this case. On the other hand, the power-supply frequency is set at 50 Hz in eastern Japan, and illumination light has a blinking cycle of 1/100 second in this case. It has been known that the occurrence cycle of screen flicker (hereinafter referred to as a “flicker frequency”) is calculated from the greatest common divisor of an imaging frequency as the frequency of the imaging cycle of an imaging apparatus and the blinking frequency of illumination light. In the related art, in order to eliminate screen flicker, correction gains to be applied to image data acquired from imaging devices are changed in synchronization with flicker frequencies.

Here, with reference to FIG. 1, a description will be given of a method of determining correction gains in the related art. FIG. 1 shows the corresponding example between a power-supply frequency and the change pattern of the brightness values of a shooting image when the power-supply frequency is set at 50 Hz and an imaging cycle is set at 120 frames. The uppermost part of FIG. 1 is a waveform graph showing the relationship between the power-supply frequency and the change of the brightness of illumination light, and shows the power-supply frequency at the upper level thereof and the change of the brightness of the illumination light at the lower level thereof. In the uppermost part of FIG. 1, the vertical axis at the upper level shows a power-supply voltage, and the vertical axis at the lower level shows the brightness. The second uppermost part of FIG. 1 shows a diagram showing the brightness of the image data of frames (frames f1 to f6) generated through the photoelectric conversion of an imaging device. The brightness of the image data of each of the frames is expressed as the area of the integral value of the image data. In the second uppermost part of FIG. 1, the horizontal axis represents a temporal axis common to the uppermost part of FIG. 1.

The second lowest part of FIG. 1 is a graph in which in-screen average brightness values obtained by dividing the integrated pixel value of the image data of each of the frames by the number of pixels are plotted on the temporal axis. The lowest part of FIG. 1 is a graph in which correction gains generated based on the in-screen average brightness values are plotted on the temporal axis. The second lowest part of FIG. 1 shows the in-screen average brightness values on the vertical axis thereof and the temporal axis common to the uppermost part and the second uppermost part of FIG. 1 on the horizontal axis thereof. In the second lowest part of FIG. 1, the in-screen average brightness values are shown by a fine dashed line, and the in-screen average brightness values assumed to be obtained when no flicker occurs are shown by a coarse dashed line. The lowest part of FIG. 1 shows the levels of the correction gains on the vertical axis thereof and the temporal axis common to the uppermost part, the second uppermost part, and the second lowest part of FIG. 1 on the horizontal axis thereof. Also in the lowest part of FIG. 1, the in-screen average brightness values assumed to be obtained when no flicker occurs are shown by a coarse dashed line, and the levels of the correction gains are shown by a fine dashed line.

As shown in the uppermost part of FIG. 1, in a case in which an image is shot using an imaging apparatus in which an imaging cycle, i.e., the exposure time of the imaging device is set at, for example, 1/120 second, the imaging apparatus has an imaging frequency of 120 Hz. When an image is shot using such an imaging apparatus under illumination light having a blinking frequency of 100 Hz, the flicker cycle of surface flicker appearing in the moving image shot by the imaging apparatus is at 20 Hz, i.e., the greatest common divisor of the imaging frequency and the blinking cycle as shown in the second lowest part of FIG. 1. It is found that fluctuations in such in-screen average brightness values are repeated every six frames, i.e., at 20 Hz.

Thus, for example, it is assumed that the in-screen average brightness value calculated in the frame f7 is the same as that calculated in the frame f1. Under such an assumption, the correction gain to be applied to the frame f7 is calculated based on the in-screen average brightness value calculated in frame f1. In other words, the correction gain of the frame to be corrected is calculated using inphase data in the flicker cycle immediately preceding the flicker cycle containing the frame to be corrected.

For example, the correction gain is obtained in such a manner that the difference between the average brightness value for one frame and the average brightness value for one cycle of a flicker frequency, i.e., for six frames is calculated as a flicker gain and the inverse of the calculated flicker gain is calculated. As shown in the lowest part of FIG. 1, the correction gain g1 calculated in the frame f1 is given to the image data of the frame f7 in the next following cycle. For example, Japanese Patent Application Laid-open No. 2001-111887 describes such a technology for determining gains for flicker correction.

### SUMMARY

However, the technology described in Japanese Patent Application Laid-open No. 2001-111887 gives rise to a problem that, even when the brightness, color, or the like of a shooting object changes instantaneously, the instantaneous change is reflected on the correction data of the next following flicker cycle. In other words, an inappropriate correction gain is applied to a frame in which the level of image data is normal (the instantaneous change of brightness or the like is not included). If such undesired correction (hereinafter referred to as “false correction”) is made, the whole or part of a screen unintentionally blinks or is given a color different from that of an actual image, which results in the image quality of a shooting image being seriously degraded.

The present disclosure has been made in view of the above circumstances, and it is therefore desirable to improve the image quality of shooting images with appropriate flicker correction.

An image data processing apparatus according to an embodiment of the present disclosure includes a brightness detection part, a moving average calculation part, a change quantity detection part, a false correction determination part, and a correction part. The configurations and functions of the respective parts are as follows. The brightness detection part is configured to detect brightness of pixels in a prescribed range of each frame from image data acquired from an imaging device in which an image is shot at a prescribed imaging frequency. The moving average calculation part is configured to calculate a moving average of prescribed cycles of the brightness detected by the brightness detection part to calculate a temporal average brightness value as an average value of the prescribed cycles of the brightness. The change quantity detection part is configured to detect a change quantity of an inclination of a waveform constituted of the temporal average brightness value calculated by the moving average calculation part. The false correction determination part is configured to determine a likelihood of false correction to the image data based on information representing a change of the inclination detected by the change quantity detection part. The correction part is configured to correct the image data acquired from the imaging device based on the determination result of the false correction determination part.

An imaging apparatus according to another embodiment of the present disclosure includes an imaging device, a brightness detection part, a moving average calculation part, a change quantity detection part, a false correction determination part, and a correction part. The configurations and functions of the respective parts are as follows. The imaging device is configured to shoot an image at a prescribed imaging frequency. The brightness detection part is configured to detect brightness of pixels in a prescribed range of each frame from image data acquired from the imaging device. The moving average calculation part is configured to calculate a moving average of prescribed cycles of the brightness detected by the brightness detection part to calculate a temporal average brightness value as an average value of the prescribed cycles of the brightness. The change quantity detection part is configured to detect a change quantity of an inclination of a waveform constituted of the temporal average brightness value calculated by the moving average calculation part. The false correction determination part is configured to determine a likelihood of false correction to the image data based on information representing a change of the inclination detected by the change quantity detection part. The correction part is configured to correct the image data acquired from the imaging device based on the determination result of the false correction determination part.

An image data processing method according to still another embodiment of the present disclosure includes the following steps. First, brightness of pixels in a prescribed range of each frame is detected from image data acquired from an imaging device in which an image is shot at a prescribed imaging frequency. Next, a moving average of prescribed cycles of the detected brightness is calculated to calculate a temporal average brightness value as an average value of the prescribed cycles of the brightness. Then, a change of an inclination of a waveform constituted of the calculated temporal average brightness value is detected. Next, a likelihood of false correction to the image data is determined based on information representing the detected change of the inclination. Then, the image data acquired from the imaging device is corrected based on the determination result.

In the embodiments of the present disclosure, determination as to whether there is a likelihood of false correction is made based on the change of the inclination of the waveform constituted of the temporal average brightness values obtained by calculating the moving average of the detected brightness values, and correction is made based on the determination result. Thus, appropriate correction is made even to areas having a high likelihood of false correction such as areas whose brightness rapidly increases with time.

According to the embodiments of the present disclosure, the image quality of shooting images is improved with appropriate flicker correction.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 shows graphs for explaining the corresponding relationship between a power-supply frequency, a flicker frequency, in-screen average brightness values, and the levels of correction gains in the related art, the uppermost part of FIG. 1 showing the power-supply frequency and the brightness and flicker frequency of illumination light, the second uppermost part of FIG. 1 showing the brightness of the illumination light, the second lowest part of FIG. 1 showing the waveform of the in-screen average brightness values, the lowest part of FIG. 1 showing the waveform of the levels of the correction gains;

FIG. 2 is a block diagram showing a configuration example of an imaging apparatus according to an embodiment of the present disclosure;

FIG. 3 is a graph in which in-screen average brightness values are plotted on the temporal axis according to the embodiment of the present disclosure;

FIG. 4 shows graphs in which the in-screen average brightness values and temporal average brightness values are plotted on the temporal axes according to the embodiment of the present disclosure, the upper part of FIG. 4 showing the in-screen average brightness values, the lower part of FIG. 4 showing the temporal average brightness values;

FIG. 5 is a graph for explaining the sizes of the differences between the in-screen average brightness values and the temporal average brightness values in areas whose brightness rapidly increases with time;

FIG. 6 shows graphs for explaining the influence of the differences between the in-screen average brightness values and the temporal average brightness values on actual flicker correction processing, the upper part of FIG. 6 being a graph in which the in-screen average brightness values, the temporal average brightness values, and brightness values after being subjected to flicker correction processing are plotted on the temporal axis, the lower part of FIG. 6 being a graph in which flicker gains are plotted on the temporal axis;

FIG. 7 shows graphs showing an example of calculating temporal average brightness average values according to the embodiment of the present disclosure, the upper part of FIG. 7 being a graph in which the in-screen average brightness values and the temporal average brightness values are plotted on the temporal axis, the lower part of FIG. 7 being a graph in which the temporal average brightness average values are plotted on the temporal axis;

FIG. 8 shows graphs showing an example of calculating averaged deviation ratios according to the embodiment of the present disclosure, the upper part of FIG. 8 being a graph in which the in-screen average brightness values, the temporal average brightness values, and the temporal average brightness average values are plotted on the temporal axis, the lower part of FIG. 8 being a graph in which the averaged deviation ratios are plotted on the temporal axis;

FIG. 9 shows graphs showing an example of switching the flicker correction processing in areas whose brightness rapidly changes with time and areas whose brightness does not rapidly change with time according to the embodiment of the present disclosure, the upper part of FIG. 9 being a graph in which the in-screen average brightness values, the temporal average brightness values, and the temporal average brightness average values are plotted on the temporal axis, the lower part of FIG. 9 being a graph in which the averaged deviation ratios are plotted on the temporal axis;

FIG. 10 is a flowchart showing an example of the flicker correction processing according to the embodiment of the present disclosure; and

FIGS. 11A and 11B are graphs showing the contrast between the flicker gains calculated according to the embodiment of the present disclosure and flicker gains calculated according to the related art, FIG. 11A being a graph in which the in-screen average brightness values as bases for calculating the flicker gains are plotted on the temporal axis, FIG. 11B being a graph in which the flicker gains calculated according to the embodiment of the present disclosure and the flicker gains calculated according to the related art are plotted on the temporal axis.

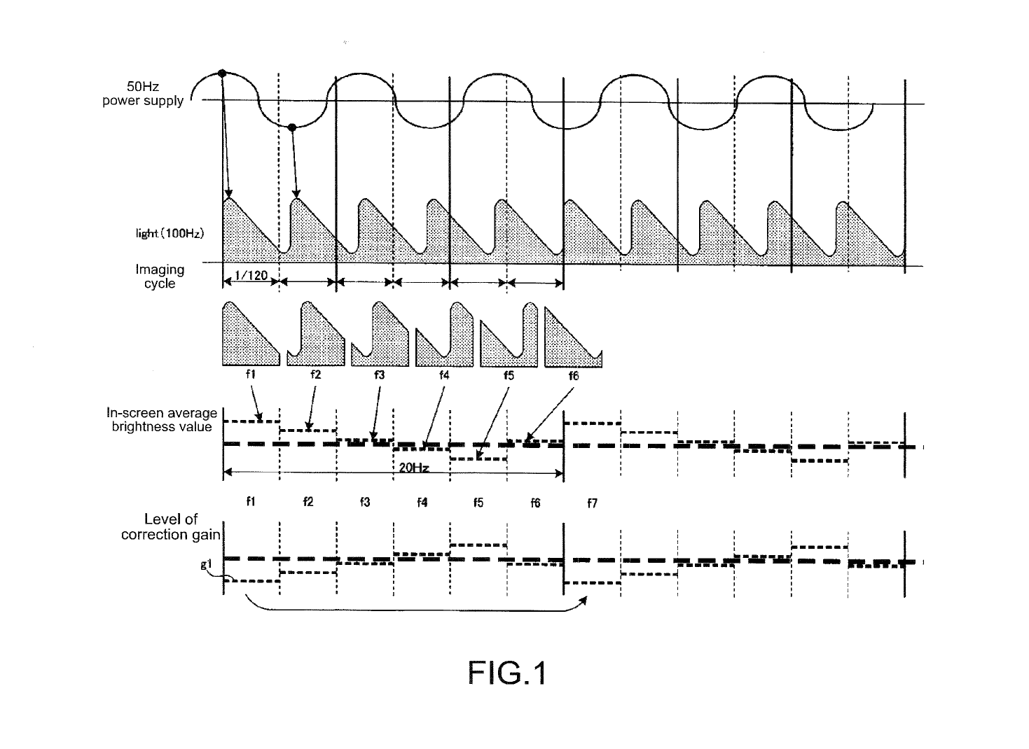

### DETAILED DESCRIPTION OF EMBODIMENTS

With reference to the drawings, a description will be given of an example of an imaging apparatus and an imaging method according to an embodiment of the present disclosure in the following order. The embodiment to be described below is a desirable specific example of the present disclosure. Therefore, various technically-desirable limitations are added to the embodiment. However, the range of the present disclosure is not limited to the embodiment unless the limitation of the present disclosure is particularly suggested in the following description. For example, the numerical condition of each parameter to be described in the following description is only a desirable example, and the size, shape, and arrangement relationship in each figure used in the description are only schematically shown.

### 1. Embodiment

(1) Configuration Example of Imaging Apparatus

(2) Operation Example of Imaging Apparatus

### 2. Various Modified Examples

### 1. Embodiment

### (1) Configuration Example of Imaging Apparatus

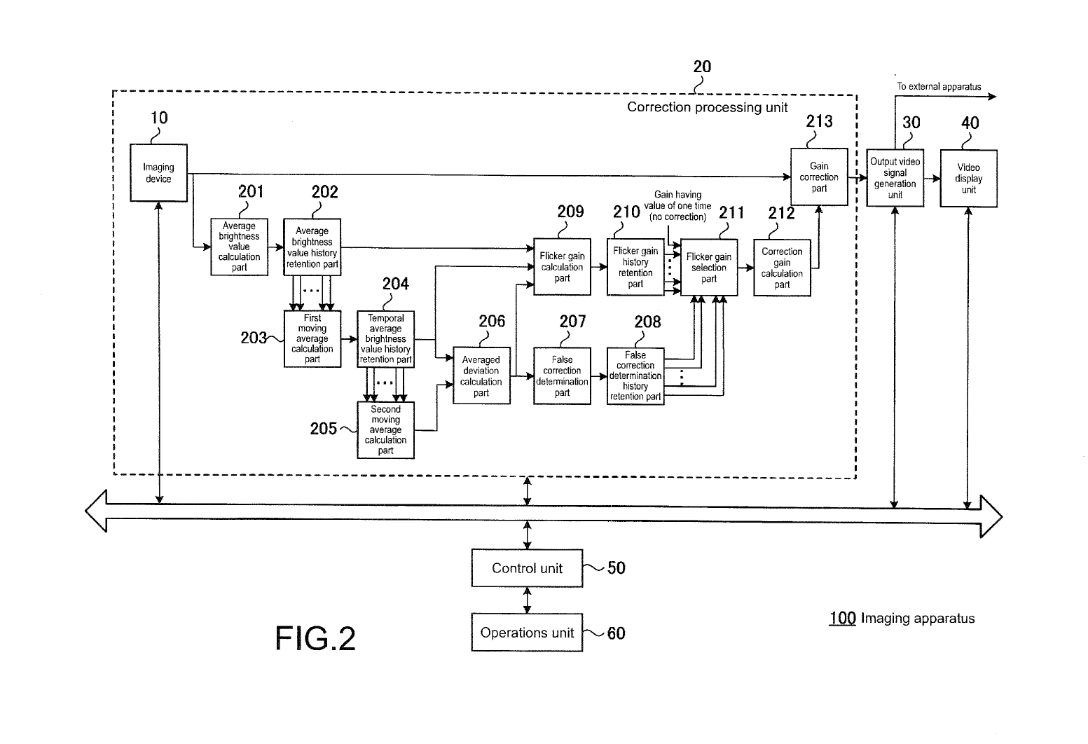

FIG. 2 is a function block diagram showing an internal configuration example of an imaging apparatus 100 according to the embodiment. The imaging apparatus 100 shown in FIG. 2 has a lens (not shown), and imaging light is formed on the imaging surface (not shown) of an imaging device 10 via the lens. The imaging device 10 is a global shutter type imaging device such as a CCD. The imaging device 10 photo-electrically converts the imaging light formed via the lens for each imaging surface to generate a prescribed analog signal and then performs the digital conversion of the analog signal to generate a prescribed digital signal (image data). Note that the image data represents an R (red), G (green), or B (blue) color signal.

Then, the image data generated by the imaging device 10 is supplied to a correction processing unit 20. In addition, the imaging device 10 has the function of switching an imaging frequency and sets the imaging frequency in an electronic shutter according to instructions from a control unit 50 to be described below. In the embodiment, the frame rate of video shot by the imaging device 10 is set at 120 fps (frames per second), i.e., an imaging frequency of 120 Hz.

The correction processing unit 20 controls the gain of the image data supplied from the imaging device 10 for each frame. Thus, the correction processing unit 20 eliminates the flicker component of screen flicker contained in the image data (hereinafter referred to as “flicker correction processing”) to generate the image data of a prescribed level. Then, the image data subjected to the flicker correction processing and generated by the correction processing unit 20 is supplied to an output video signal generation unit 30. The correction processing unit 20 separately performs the gain control of the image data for each of a color signal (red), a color signal (green), and a color signal (blue). However, since the correction processing unit 20 performs the same processing for each of the color signal (red), the color signal (green), and the color signal (blue), the description of the processing for each of these three signals will be omitted below. In addition, the correction processing unit 20 will be described in detail below.

The output video signal generation unit 30 performs signal processing such as processing for correcting a decrease in peripheral light quantity of each frame of the image data supplied from the correction processing unit 20, prescribed interpolation processing, and filtering and shading processing associated with these processing. In addition, the output video signal generation unit 30 performs processing for improving image quality, or the like. Moreover, the output video signal generation unit 30 performs known image processing such as tone control processing, brightness compression processing, and gamma correction processing on the image data supplied from the correction processing unit 20 to generate a video signal to be input to a prescribed display apparatus.

Then, the video signal subjected to such image processing is supplied to an external apparatus such as a personal computer as well as being reflected as video in a display unit 40 including a liquid crystal display or the like. Note that the flicker correction processing of the correction processing unit 20 and other correction processing of the output video signal generation unit 30 are performed based on the control of a control unit 50 to be described below.

The control unit 50 includes a micro computer or the like and controls each unit constituting the imaging apparatus 100. More specifically, the control unit 50 controls the setting of the imaging frequency of the imaging device 10, the setting of the gain on the correction processing unit 20, or the like. In addition, the control unit 50 controls the operations of each unit such as an optical system including a lens (not shown) and the imaging device 10. To this end, the control unit 50 is connected to each unit inside the imaging apparatus 100 so as to enable data transmission.

An operations unit 60 includes button keys disposed in the imaging apparatus 100, soft keys allocated to icons displayed on the screen of the display unit 40 mounted in the imaging apparatus 100, or the like. Alternatively, the operations unit 60 is configured as a remote controller. Then, an operation signal according to the operation of a user is input from the operations unit 60 to the control unit 50 via a prescribed interface (not shown). For example, an operation signal for setting a power-supply frequency (50 Hz or 60 Hz) is input from the operations unit 60 to the control unit 50.

The control unit 50 performs prescribed calculation and control with respect to each circuit according to a computer program stored in a non-volatile storage unit such as a built-in ROM (Read Only Memory) based on the operation signal, prescribed settings, or the like.

Next, with reference also to FIG. 2, a description will be given in detail of the correction processing unit 20. The correction processing unit 20 has an average brightness value calculation part 201 as a brightness detection part. In addition, the correction processing unit 20 has an average brightness value history retention part 202 and a first moving average calculation part 203 as a moving average calculation part. Moreover, the correction processing unit 20 has a temporal average brightness value history retention part 204 and a second moving average calculation part 205. Further, the correction processing unit 20 has an averaged deviation calculation part 206 as a change quantity detection part, a false correction determination part 207, and a false correction determination history retention part 208. Furthermore, the correction processing unit 20 has a flicker gain calculation part 209, a flicker gain history retention part 210, a flicker gain selection part 211, a correction gain calculation part 212, and a gain correction part 213.

The average brightness value calculation part 201 calculates an integrated brightness value Bi for one screen region using image data obtained by the imaging device 10. Then, the average brightness value calculation part 201 divides the calculated integrated brightness value Bi by the number of the pixels of the one screen region to calculate average brightness values in the one screen region (hereinafter referred to as “in-screen average brightness values By”). The one screen region represents one of regions obtained by dividing one screen into some pieces. The embodiment describes as an example a case in which one screen is divided into four pieces.

If a plurality of illumination lamps exist, the levels and occurrence frequencies of flicker (blinking) are changed depending on distances from the respective light sources, angles between the light sources and a surface, or the like. For example, in the case of baseball game lives or the like, the levels and occurrence frequencies of flicker are different between areas where a fence is reflected and areas where a ground is reflected. Therefore, average brightness values are calculated for each screen region, and then correction gains are calculated based on the calculated average brightness values. Consequently, the flicker correction processing appropriate for each screen region may be performed. The embodiment includes but not limited to the case in which one screen is divided into four pieces. That is, the screen may be divided into other pieces. Alternatively, the average brightness value of the whole screen may be calculated without the division of the screen.

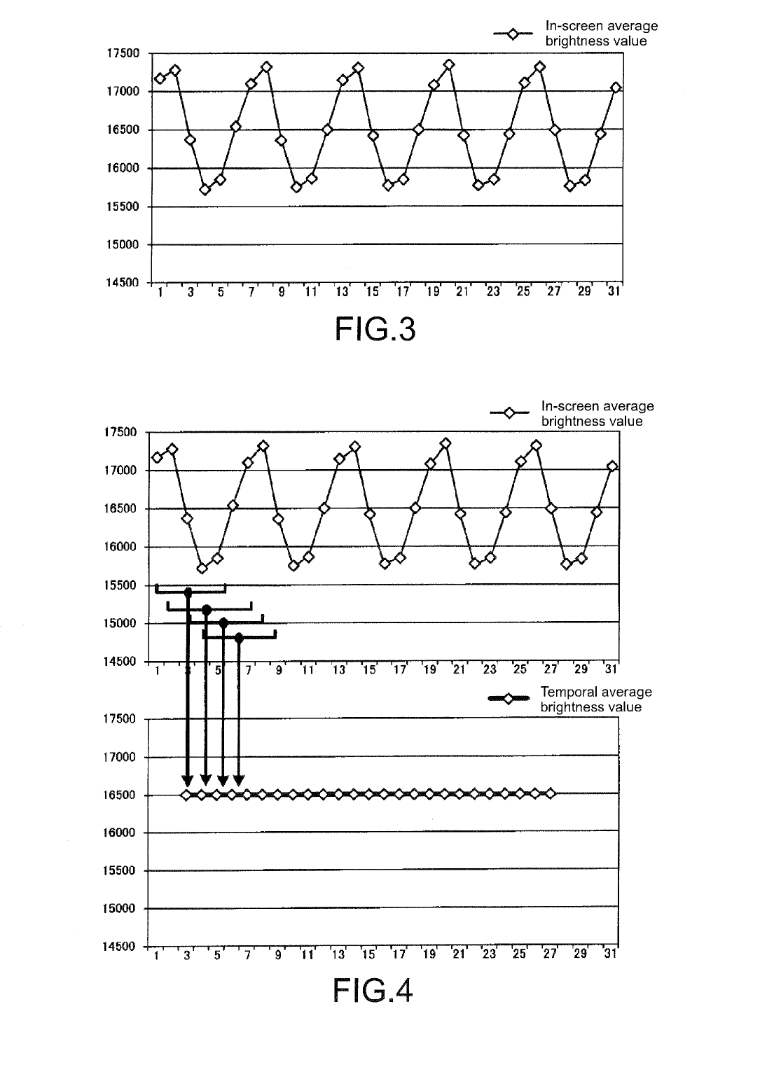

FIG. 3 is a graph in which in-screen average brightness values Bv calculated in one screen region are plotted on the temporal axis. FIG. 3 shows the digital values of pixel values on the vertical axis thereof and a temporal axis (frames) on the horizontal axis thereof. In FIG. 3, respective values calculated in the one screen region composed of the first to 31th frames constituting the one screen region are shown as the in-screen average brightness values Bv for the one screen region. FIG. 3 shows an example of a case in which there is no rapid brightness change between the adjacent frames. In such a case, the change pattern of the in-screen average brightness values Bv in the temporal direction nearly synchronizes with a flicker frequency.

With reference back to FIG. 2, the description will be continued. The average brightness value calculation part 201 outputs the calculated in-screen average brightness values Bv to the average brightness value history retention part 202 one after another. The average brightness value history retention part 202 includes a memory or the like and retains the latest prescribed number of N data among the in-screen average brightness values Bv input from the average brightness value calculation part 201. The value of N is 120 or the like, which represents the number of frames per second. According to the value of N, the maximum length of chronological data to be chronologically stored is defined.

The average brightness value history retention part 202 deletes the oldest data for each input of the latest in-screen average brightness value Bv and then moves down addresses, in which the in-screen average brightness values Bv are stored, one by one. Assuming that a region storing the data of the n-th oldest in-screen average brightness value Bv is Bv(n), the content of a storage region Bv(n) is moved to a storage region Bv(n+1) and the latest in-screen average brightness value Bv is stored in a storage region Bv(1). Here, “n” includes any value ranging from “1” to “N−1.”

The first moving average calculation part 203 reads the in-screen average brightness values Bv for six frames corresponding to one cycle of a flicker cycle from the average brightness value history retention part 202 in a stored order to calculate the moving average of the in-screen average brightness values Bv. Assuming that the results of calculating the moving average are “temporal average brightness values Av,” the temporal average brightness values Av may be calculated based on the following formula 1.

Temporal average brightness values Av=(In-screen average brightness values Bv(1)+Bv(2)+ , , , +Bv(M))/Flicker cycle M (formula 1)

FIG. 4 shows graphs for explaining an example of processing for calculating the temporal average brightness values Av by the first moving average calculation part 203. The upper part of FIG. 4 is a graph in which the transition of the in-screen average brightness values Bv shown in FIG. 3 is shown on the temporal direction, and the lower part of FIG. 4 is a graph in which the temporal average brightness values Av calculated by the first moving average calculation part 203 are plotted on the temporal axis. FIG. 4 also shows the brightness values on the vertical axes thereof and the temporal axis on the horizontal axes thereof. If there is no rapid brightness change between the adjacent frames, the in-screen average brightness values Bv change with six frames as one cycle. Accordingly, If there is almost no change in the brightness of a shooting image, almost the same values are continuously output as the temporal average brightness values Av, i.e., the average values of the in-screen average brightness values for six frames as shown in the lower part of FIG. 4. The temporal average brightness values Av output from the first moving average calculation part 203 are stored in the temporal average brightness value history retention part 204 one after another.

The temporal average brightness value history retention part 204 includes a memory or the like and retains the latest N data among the temporal average brightness values Av output from the first moving average calculation part 203. The temporal average brightness value history retention part 204 deletes the oldest data for each input of the latest temporal average brightness value Av and then moves down addresses, in which the temporal average brightness values Av are stored, one by one. Assuming that a region storing the data of the n-th oldest temporal average brightness value Av is Av(n), the content of a storage region Av(n) is moved to a storage region Av(n+1) and the latest temporal average brightness value Av is stored in a storage region Av(M/2). Here, “n” includes any value ranging from “M/2” to “N−1.” “M/2” is set as a delay portion caused by the processing for calculating the average values. In other words, the temporal average brightness value Av calculated using the data of the first to sixth frames as shown in the upper part of FIG. 4 is stored as the temporal average brightness value (=Av(3)) of the third frame as shown in the lower part of FIG. 4.

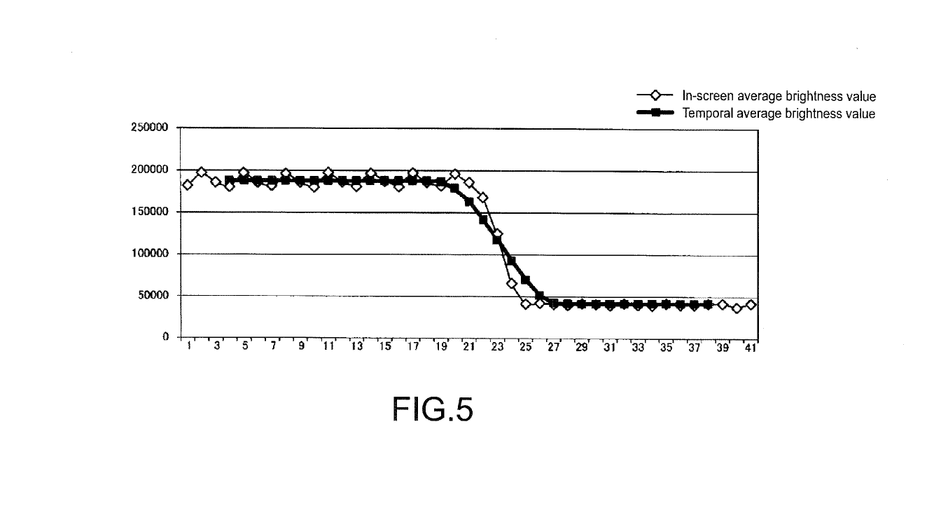

FIG. 5 is a graph in which the in-screen average brightness values Bv calculated by the average brightness value calculation part 201 and the temporal average brightness values Av calculated by the first moving average calculation part 203 are plotted on the temporal axis. In FIG. 5, the in-screen average brightness values Bv are shown by a broken line with rhombic marks, and the temporal average brightness values Av are shown by a broken line with square marks.

FIG. 5 shows a state in which the in-screen average brightness value Bv at a brightness level of about 200,000 in the 20th frame or so drops down to a brightness level of about 50,000 in the 25th frame or so. In other words, the brightness rapidly changes between only the five frames. In the area whose brightness rapidly changes with time as described above, the inclination of the waveform of the temporal average brightness values Av whose values are smoothed by averaging the in-screen average brightness values Bv for the six frames is smoothed to some extent. Because of this, in such an area, the differences between the in-screen average brightness values Bv as brightness actually detected and the temporal average brightness values Av obtained by averaging the in-screen average brightness values Bv become large.

In the related art, values obtained by dividing the in-screen average brightness values Bv by the temporal average brightness values Av are set as flicker gains, and the inverses of the obtained flicker gains are set as flicker correction gains. The flicker gains are ideally brightness values assumed to be obtained when no flicker occurs, i.e., values showing the ratios of actual brightness to “true brightness.” If such ideal flicker gains are obtained, it is possible to properly eliminate flicker components from video signals with flicker correction using the flicker correction gains calculated from the ideal flicker gains.

However, since it is actually difficult to obtain such “true brightness,” the temporal average brightness value Av is used instead as “true brightness” for the sake of convenience. For this reason, in a case in which the brightness rapidly changes with time as shown in FIG. 5, the values of the temporal average brightness values Av used as the approximate values of the “true brightness” become far apart from the in-screen average brightness values Bv. Accordingly, the flicker gains obtained by dividing the in-screen average brightness values Bv by the temporal average brightness values Av become far apart from those having a value of one time, which results in the flicker correction being made to a large extent. In other words, the occurrence of flicker is falsely detected although no flicker actually occurs, and false correction is made based on the false detection.

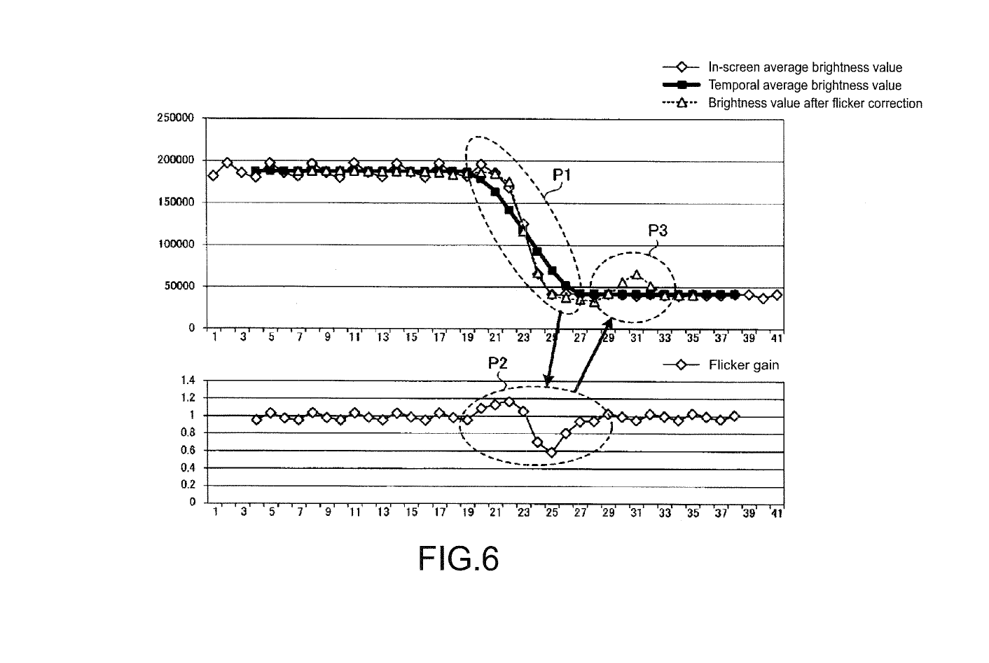

FIG. 6 shows graphs for explaining the influence of the differences between the in-screen average brightness values Bv and the temporal average brightness values Av on actual flicker correction processing. The upper part of FIG. 6 is a graph in which the in-screen average brightness values Bv, the temporal average brightness values Av, and the brightness values after being subjected to the flicker correction processing are plotted on the temporal axis. The lower part of FIG. 6 is a graph in which the flicker gains calculated using the in-screen average brightness values Bv and the temporal average brightness values Av shown in the upper part of FIG. 6 are plotted on the temporal axis.

In the upper part of FIG. 6, the in-screen average brightness values Bv are shown by a broken line with rhombic marks, and the temporal average brightness values Av are shown by a broken line with square marks. The brightness values after being subjected to the flicker correction are shown by a broken line with triangle marks. The upper part of FIG. 6 shows the levels of the brightness on the vertical axis thereof, and the lower part of FIG. 6 shows the sizes of the flicker gains on the vertical axis thereof. FIG. 6 shows the temporal axis (frames) on the horizontal axes thereof.

In the upper part of FIG. 6, in the 20th to 27th frames or so encircled by a dashed line as a period P1, the in-screen average brightness values Bv rapidly change with time, whereby the differences between the in-screen average brightness values Bv and the temporal average brightness values Av also become large. Accordingly, the flicker gains obtained by dividing the in-screen average brightness values Bv by the temporal average brightness values Av also become large in the 19th to 29th frames or so encircled by a dashed line as a period P2 in the lower part of FIG. 6. Specifically, the flicker gains having shifted at a value of one time or so in a previous period have a value of about +1.2 times in the 22th frame or so and a value of about −0.6 time in the 25th frame or so, which become largely apart from the value of one time.

By the multiplication of the flicker correction gains calculated based on such flicker gains, the brightness values after the flicker correction in the 30th to 32th frames or so encircled by a dashed line as a period P3 in the upper part of FIG. 6 become larger than the in-screen average brightness values Bv. In other words, the flicker correction is made to a large extent although almost no flicker actually occurs in the period P3. Since an area in which such false correction is made has a brightness value different from those in temporally-successive adjacent periods, it appears to blink on the screen. Particularly, in a case in which an object with many specific color components such as R (red) suddenly appears in a shooting scene, the flicker correction is made only to the color R to a large extent, which results in an undesired color being added to the shooting image.

According to the embodiment, in order to prevent the occurrence of such false correction, known correction using data preceding by a prescribed flicker cycle such as one flicker cycle is not made to areas in which there is a likelihood of the false correction. Determination as to whether there is a likelihood of the false correction is made based on the sizes of the differences between the temporal average brightness values Av and temporal average brightness average values Avv obtained by further calculating the moving average of the temporal average brightness values Av. In the following description, the differences between the temporal average brightness values Av and the temporal average brightness average values Avv are referred to as “averaged deviations D.”

With reference back to FIG. 2, the description will be continued. The second moving average calculation part 205 reads the temporal average brightness values Av for six frames corresponding to one cycle of a flicker cycle from the temporal average brightness value history retention part 204 in a stored order to calculate the moving average of the temporal average brightness values Av. In other words, the temporal average brightness average values Avv are calculated. The temporal average brightness average values Avv may be calculated based on the following formula 2.

Temporal average brightness average values=(Temporal average brightness values Av(M/2)+Av(M/2+1)+ , , , +Av(M/2+M−1))/Flicker cycle M (formula 2)

In other words, the temporal average brightness average values Avv are calculated using the temporal average brightness values Av for six flicker cycles M with the temporal average brightness value Av stored in the third address (=Av(M/2)) as an origin. The sixth address with Av(M/2) as the origin is the address of Av(M/2+M−1).

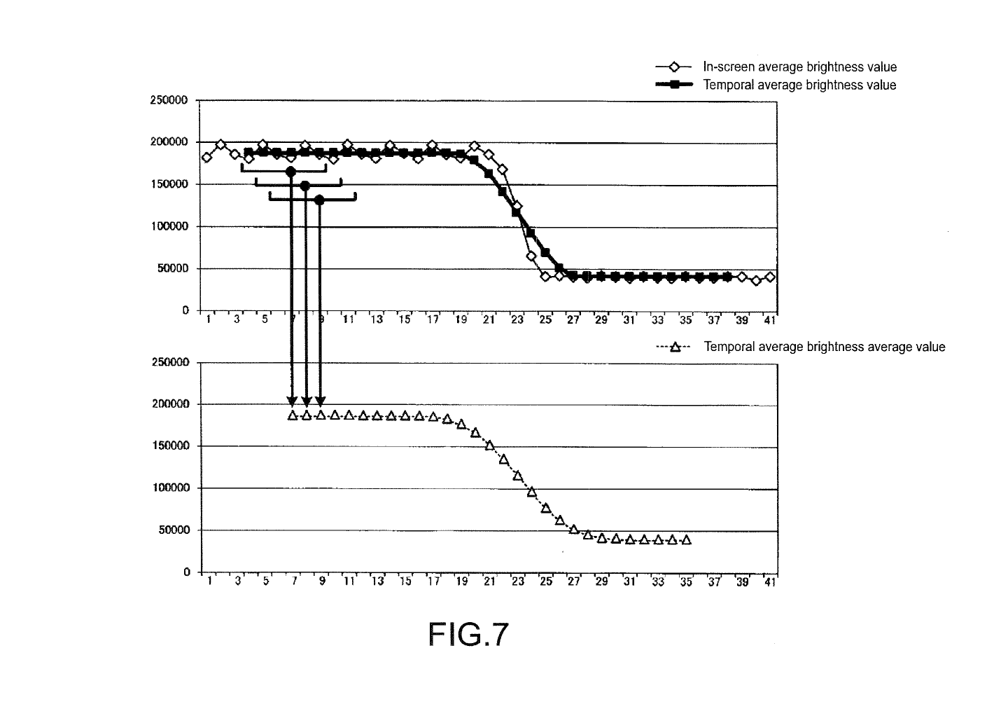

FIG. 7 shows graphs for explaining an example of calculating the temporal average brightness average values Avv. The upper part of FIG. 7 is a graph in which the in-screen average brightness values Bv and the temporal average brightness values Av are plotted on the temporal axis, and the lower part of FIG. 7 is a graph in which the temporal average brightness average values Avv are plotted on the temporal axis. As described above, the temporal average brightness average values Avv are the average values of the temporal average brightness values Av for six frames. Therefore, as shown in the lower part of FIG. 7, the inclination of the waveform of such average values is further smoothed than that of the waveform of the temporal average brightness values Av shown in the upper part of FIG. 7. The further calculation of the moving average of the temporal average brightness values Av is to smooth the temporal average brightness values Av to reduce the change of the inclination of the waveform. In other words, by the calculation of the averaged deviations D as the differences between the temporal average brightness average values Avv and the temporal average brightness values Av, the change of the inclination of the temporal average brightness values Av is found.

It can be said that the averaged deviations D as the differences between the temporal average brightness average values Avv and the temporal average brightness values Av indicate the deviations between the in-screen average brightness values Bv and the temporal average brightness values Av generated when the waveform is smoothed by averaging. Assuming that the ratios of the averaged deviations D to the temporal average brightness values Av are averaged deviation ratios Dr, the larger the values of the averaged deviation ratios Dr, the larger the deviations between the in-screen average brightness values Bv and the temporal average brightness values Av become. According to the embodiment, known correction using data preceding by a prescribed flicker cycle is not made in a case in which the values of the averaged deviation ratios Dr exceed a prescribed threshold. In addition, values obtained by subtracting the averaged deviations D from the temporal average brightness average values Avv are used as the approximate values of “true brightness” instead of the temporal average brightness values Av to increase the estimated accuracy of flicker gains under specific conditions.

With reference back to FIG. 2, the description will be continued. The averaged deviation calculation part 206 calculates the averaged deviations D described above. In addition, the averaged deviation calculation part 206 calculates the “averaged deviation ratios Dr” representing the sizes of the ratios of the calculated averaged deviations D to the temporal average brightness values Av. The averaged deviation ratios Dr are values obtained by dividing the averaged deviations D by the temporal average brightness average values Avv. The averaged deviation calculation part 206 outputs the calculated averaged deviations D to the false correction determination part 207 and the averaged deviation ratios Dr to the flicker gain calculation part 209.

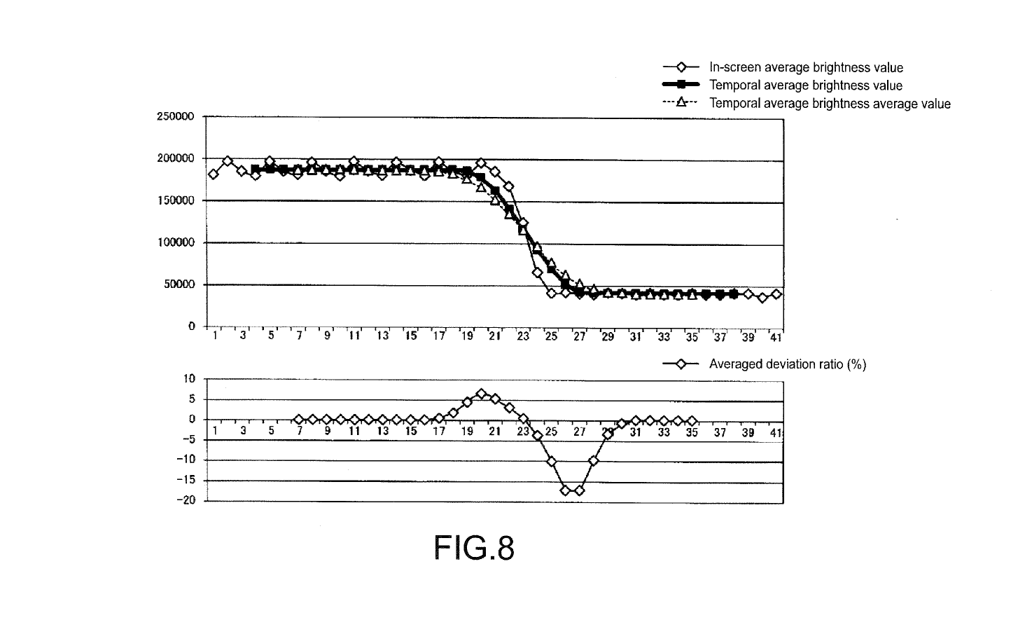

FIG. 8 shows graphs showing the contrast between the averaged deviation ratios Dr and the in-screen average brightness values Bv, the temporal average brightness values Av, and the temporal average brightness average values Avv. The upper part of FIG. 8 is a graph in which the in-screen average brightness values Bv, the temporal average brightness values Av, and the temporal average brightness average values Avv are plotted on the temporal axis, and shows the brightness values on the vertical axis thereof and the temporal axis (frames) on the horizontal axis thereof.

In the upper part of FIG. 8, the in-screen average brightness values Bv are shown by a broken line with rhombic marks, and the temporal average brightness values Av are shown by a broken line with square marks. The temporal average brightness average values Avv are shown by a broken line with triangle marks. The lower part of FIG. 8 is a graph in which the averaged deviation ratios Dr are plotted on the temporal axis and shows the ratios (%) on the vertical axis thereof and the temporal axis (frames) on the horizontal axis thereof.

It is shown in the upper part of FIG. 8 that the differences between the in-screen average brightness values Bv and the temporal average brightness values Av become large in the 20th to 25th frames or so. In addition, as shown in the lower part of FIG. 8, the values of the averaged deviation ratios also become large in this period. On the other hand, in areas in which the differences between the in-screen average brightness values Bv and the temporal average brightness values Av are not large, the values of the averaged deviation ratios Dr also become small. In other words, it is found that the sizes of the averaged deviation ratios Dr correspond to the differences between the in-screen average brightness values Bv and the temporal average brightness values Av.

With reference back to FIG. 2, the description will be continued. The false correction determination part 207 determines whether there is a likelihood of the false correction of flicker correction based on the sizes of the averaged deviation ratios Dr output from the averaged deviation calculation part 206, and then reflects the determination result on the values of flags F. More specifically, if the absolute values of the averaged deviation ratios Dr are larger than a prescribed threshold T, the false correction determination part 207 sets the values of the flags F at “1” with an assumption that there is a high likelihood of the false correction. On the other hand, if the absolute values of the averaged deviation ratios Dr are less than or equal to the threshold T, the false correction determination part 207 sets the values of the flags F at “0” with an assumption that there is a low likelihood of the false correction. As the threshold T, ±2% is, for example, set. However, other values may be set instead. The false correction determination part 207 outputs the updated values of the flags F to the false correction determination history retention part 208 and the flicker gain selection part 211.

The false correction determination history retention part 208 includes, for example, a memory and retains, for example, the 120 values of the flags F output from the false correction determination part 207 corresponding to the number of frames for one second. Then, the false correction determination history retention part 208 deletes the oldest data stored therein for each input of the value of the latest flag F, and then moves down addresses, in which the values of the flags F are stored, one by one. The flicker gain calculation part 209 calculates the flicker gains Fg based on the following formula 3.

Flicker gains Fg=In-screen average brightness values Bv/(Temporal average brightness values Av−Averaged deviations D) (formula 3)

In other words, values obtained by dividing the in-screen average brightness values Bv by the difference values between the temporal average brightness values Av and the averaged deviations D are referred to as the flicker gains Fg.

The flicker gain calculation part 209 sequentially outputs the calculated flicker gains Fg to the flicker gain history retention part 210. The flicker gain history retention part 210 includes, for example, a memory and retains, for example, the 120 values of the flicker gains Fg output from the flicker gain calculation part 209 corresponding to the number of frames for one second. Then, the flicker gain history retention part 210 deletes the oldest data stored therein for each input of the value of the latest flicker gain Fg, and then moves down addresses, in which the values of the flicker gains Fg are stored, one by one.

The flicker gain selection part 211 selects the flicker gain Fg used to calculate the flicker correction gain based on the values of the flags F stored in the false correction determination history retention part 208. Specifically, the flicker gain selection part 211 first reads the most-recently stored flag F from those stored in the false correction determination history retention part 208. Then, if the value of the flag is “0,” i.e., if there is a low likelihood of the false correction, the flicker gain selection part 211 reads the flicker gain Fg corresponding to the read flag F from the flicker gain history retention part 210 and outputs the same to the correction gain calculation part 212.

If the value of the flag F is “1,” i.e., if there is a high likelihood of the false correction, the flicker gain selection part 211 goes back to the past in increments of the flicker cycle M to search for the values of the flags F until the flag F having a value of 0 is found. If the flag F having a value of 0 is found, the flicker gain selection part 211 reads the flicker gain Fg corresponding to the flag F from the flicker gain history retention part 210 and outputs the same to the correction gain calculation part 212.

However, if the flicker gain selection part 211 excessively goes back to the past, it is highly likely that the flicker cycle, amplitude, and phase of flicker in the past are different from those of the flicker occurring in the present frame. Therefore, the number of cycles for which the flicker gain selection part 211 goes back to the past is limited to a prescribed number in advance. The number of cycles for which the flicker gain selection part 211 is allowed to go back to the past may be set at, for example, 20 cycles or the like corresponding to one second (120 frames). The appropriate number of cycles for which the flicker gain selection part 211 is allowed to go back to the past is different depending on scenes for shooting images, and thus any value may be set.

If the value of the flag F is “1” and the flag F having a value of “0” is not found even when the flicker gain selection part 211 goes back to the past by prescribed cycles, the flicker gain selection part 211 selects the flicker gain Fg having a value of one time. In other words, the flicker gain selection part 211 does not make the flicker correction.

The correction gain calculation part 212 calculates the flicker correction gain Fc using the flicker gain Fg selected by the flicker gain selection part 211. The flicker correction gain Fc may be calculated based on the following formula 4.

Flicker correction gain Fc=1/Flicker gain Fg (formula 4)

In other words, the inverse of the flicker gain Fg is set as the flicker correction gain Fc.

The gain correction part 213 multiplies the image data output from the imaging device 10 by the flicker correction gain Fc calculated by the correction gain calculation part 212.

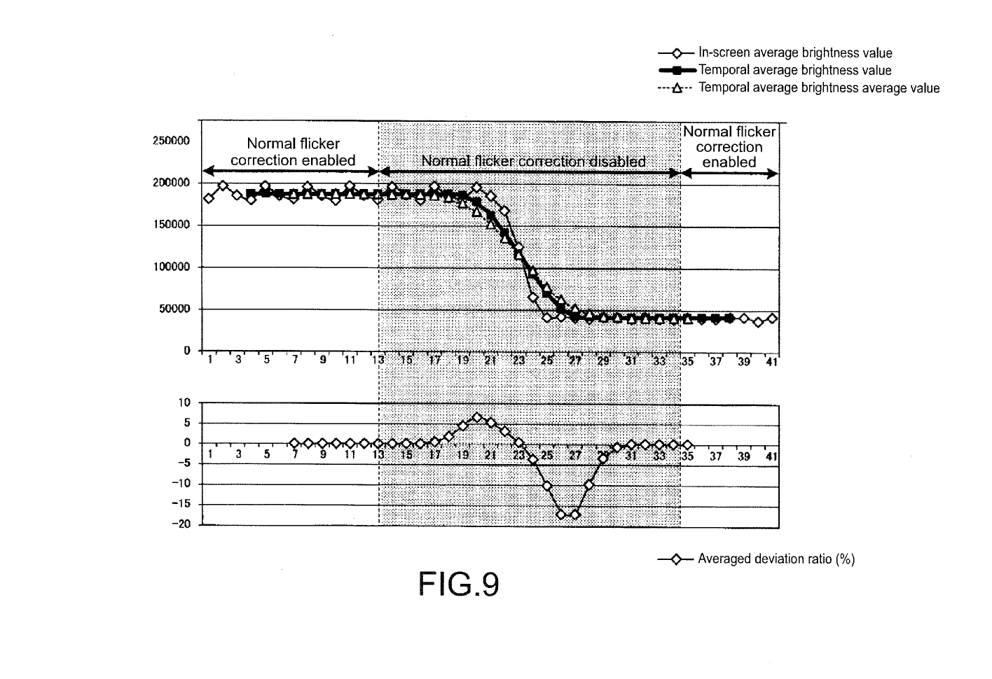

FIG. 9 shows graphs showing an example of a case in which the flicker gain selection part 211 does not make normal flicker correction using inphase data preceding by a prescribed flicker cycle as in the related art. The upper part of FIG. 9 is a graph in which the in-screen average brightness values Bv, the temporal average brightness values Av, and the temporal average brightness average values Avv are plotted on the temporal axis. The upper part of FIG. 9 shows the brightness values on the vertical axis thereof and the temporal axis (frames) on the horizontal axis thereof. The lower part of FIG. 9 is a graph in which the averaged deviation ratios Dr calculated from the temporal average brightness values Av and the temporal average brightness average values Avv shown in the upper part of FIG. 9 are plotted on the temporal axis. The lower part of FIG. 9 shows the ratios (%) on the vertical axis thereof and the temporal axis (frames) on the horizontal axis thereof.

As shown in the lower part of FIG. 9, the averaged deviation ratios Dr become large in the 20th frame or so and the 26th frame or so in which the in-screen average brightness values Bv rapidly change. As a result, in the 19th to 22th frames or so and the 24th to 29th frames or so, the averaged deviation ratios Dr exceed ±2% set as the threshold T. If the averaged deviation ratios Dr exceed the threshold T, the flags F representing a likelihood of the false correction are set at “1” as described above. Then, the flicker gain selection part 211 goes back to the past in increments of the flicker cycle M to search for the values of the flags F until the flag F having a value of “0” is found. In other words, the flicker gain selection part 211 does not make the flicker correction using inphase data preceding by a prescribed cycle as in the related art.

Note that if periods in which the averaged deviation ratios Dr exceed the threshold T are strictly extracted, the 23th frame or so and the 31th frame or so shown in the lower part of FIG. 9 are not extracted. This is because the averaged deviation ratios Dr in these frames are “0” percent and thus the flags F are set at “0.” However, it is assumed that there is a high likelihood of the false correction of flicker even in the period between the periods in which the averaged deviation ratios Dr exceed the threshold T. Therefore, according to the embodiment, not only the frames in which the averaged deviation ratios Dr exceed the threshold T but also a prescribed number of frames prior to and subsequent to the frames are set as frames having a high likelihood of the false correction of flicker. As the number of prior and subsequent frames, one flicker cycle or the like is, for example, set.

Thus, as shown in the lower part of FIG. 9, the normal flicker correction is disabled between the 13th frame preceding by one flicker cycle from the 19th frame in which the flag F having a value of “1” is first detected and the 34th frame coming by the one flicker cycle after the 29th frame finally detected. Here, the normal flicker correction represents the flicker correction using inphase data preceding by a prescribed cycle. Then, instead of disabling the normal flicker correction, the flicker correction gain Fc is calculated using the flicker gain Fg having a low likelihood of the false correction among the flicker gains Fg calculated in the past, and the flicker correction is performed using the calculated flicker correction gain Fc. If the flicker gain Fg having a low likelihood of the false correction is not found, the flicker correction itself is disabled.

### (2) Operation Example of Imaging Apparatus

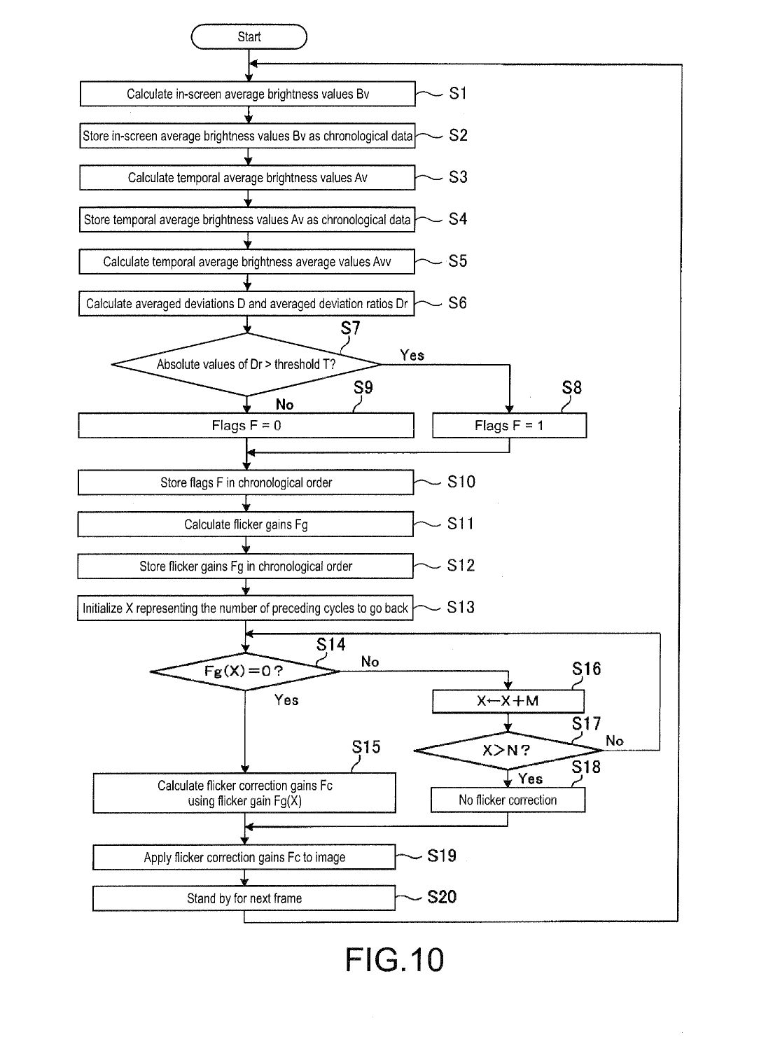

Next, with reference to a flowchart shown in FIG. 10, a description will be given of the flicker correction processing of the imaging apparatus 100 according to the embodiment. First, the imaging device 10 inputs image data to the correction processing unit 20 (see FIG. 2). Then, the average brightness value calculation part 201 of the correction processing unit 20 sequentially calculates in-screen average brightness value Bv for each frame from the input image data (step S1). The average brightness value calculation part 201 outputs the calculated in-screen average brightness value Bv to the average brightness value history retention part 202 for each calculation of the in-screen average brightness value Bv. In other words, the average brightness value calculation part 201 stores the in-screen average brightness values Bv in the average brightness value history retention part 202 as chronological data (step S2).

Next, the first moving average calculation part 203 calculates temporal average brightness values Av as the average values of the in-screen average brightness values Bv for one flicker cycle (step S3). The first moving average calculation part 203 outputs the temporal average brightness values Av to the temporal average brightness value history retention part 204 one after another in a calculated order. In other words, the first moving average calculation part 203 stores the temporal average brightness values Av in the temporal average brightness value history retention part 204 as chronological data (step S4). Then, the second moving average calculation part 205 calculates temporal average brightness average values Avv as the average values of the temporal average brightness values Av for one flicker cycle (step S5).

Next, the averaged deviation calculation part 206 calculates averaged deviations D as the differences between the temporal average brightness values Av and the temporal average brightness average values Avv and averaged deviation ratios Dr representing the ratios of the averaged deviations D to the temporal average brightness values Av (step S6). The averaged deviation calculation part 206 outputs the calculated averaged deviations D to the flicker gain calculation part 209 and the averaged deviation ratios Dr to the false correction determination part 207. Then, the false correction determination part 207 determines whether the absolute values of the averaged deviation ratios Dr are larger than a prescribed threshold T (step S7). If the absolute values of the averaged deviation ratios Dr are larger than the prescribed threshold T, the false correction determination part 207 assigns the value “1” representing a high likelihood of false correction to flags F representing a likelihood of false correction (step S8). If the absolute values of the averaged deviation ratios Dr are less then or equal to the threshold T, the false correction determination part 207 assigns the value “0” representing a low likelihood of false correction to the flags F (step S9). The false correction determination history retention part 208 stores the flags F, where the prescribed values have been assigned by the false correction determination part 207, in a chronological order (step S10).

Next, the flicker gain calculation part 209 calculates flicker gains Fg (step S11). As described above, the flicker gain calculation part 209 calculates the flicker gains Fg in such a manner that the in-screen average brightness values Bv are divided by values obtained by subtracting the averaged deviations D from the temporal average brightness values Av. The flicker gain calculation part 209 outputs the flicker gains Fg to the flicker gain history retention part 210 to be stored there one after another in a calculated order. In other words, the flicker gain calculation part 209 stores the flicker gains Fg in the flicker gain history retention part 210 in a chronological order (step S12).

Then, the flicker gain selection part 211 initializes the value of a cycle X representing how many flicker cycles of preceding data is to be used (step S13). As the cycle X, 2M or the like is, for example, set. An appropriate value is set as the cycle X according to the types of scenes for shooting images and may be freely set by a user. If 2M is set as the cycle X, the flicker gain Fg preceding by (2×6=) 12 frames is set as a flicker gain candidate for calculating a flicker correction gain Fc. The flicker gain selection part 211 reads from the false correction determination history retention part 208 the flag F(X) corresponding to the flicker gain Fg preceding by the 12 frames, i.e., the flag F(X) as the flag F preceding by the 12 frames. Then, the flicker gain selection part 211 determines whether the flag F(X) is “0” (step S14).

If the flag F(X) is “0,” the flicker gain selection part 211 selects the flicker gain preceding by X-frame, i.e., the 12th flicker gain Fg(X). Then, the correction gain calculation part 212 calculates the flicker correction gain Fc using the selected flicker gain Fg(X) (step S15). On the other hand, if the flag F(X) is “1,” “X+M” is assigned to the cycle X (step S16). In other words, the flicker gain selection part 211 is caused to go back to the past by another one flicker cycle. Next, the flicker gain selection part 211 determines whether the value of X is larger than N, i.e., the maximum length of data stored as chronological data (step S17). If X>N, the flicker gain selection part 211 does not make flicker correction (step S18). In other words, the flicker gain selection part 211 sets the flicker correction gain having a value of one time. If X≧N, the flicker gain selection part 211 returns to step S14 to continue the determination.

Then, the gain correction part 213 makes correction to the image data output from the imaging device 10 using the flicker correction gain Fc selected by the flicker gain selection part 211 (step S19). After the correction, the gain correction part 213 is on standby until the image data of the next frame is input from the imaging device 10 (step S20). If the image data of the next frame is input from the imaging device 10, the gain correction part 213 returns to step S1 to continue the processing.

According to the embodiment of the present disclosure described above, the normal flicker correction using inphase data preceding by a prescribed flicker cycle is not allowed when there is a likelihood of the false correction of flicker. Accordingly, it is possible to reduce the occurrence of undesired blinking and the addition of undesired colors in areas whose brightness rapidly increases with time or the like.

In addition, according to the embodiment, determination as to whether there is a likelihood of the false correction of flicker is made based on the sizes of the averaged deviation ratios, i.e., the ratios of the averaged deviations D as the differences between the temporal average brightness values Av and the temporal average brightness average values Avv to the temporal average brightness values Av. The temporal average brightness average values Avv are those obtained by further calculating the moving average of the temporal average brightness values Av obtained by calculating the moving average of the in-screen average brightness values Bv. In other words, it can be said that the temporal average brightness average values Avv are those obtained by smoothing the temporal average brightness values Av to reduce the change of the inclination of the waveform. It can be said that the averaged deviations D as the differences between the temporal average brightness average values Avv and the temporal average brightness values Av represent information on how rapidly the in-screen average brightness values Bv change with time. In other words, the averaged deviations D represent the sizes of the deviations between the in-screen average brightness values Bv and the temporal average brightness values Av caused when the brightness rapidly changes with time.

Accordingly, in areas whose brightness rapidly increases, the averaged deviation ratios Dr become large enough to exceed the threshold T. If the averaged deviation ratios Dr exceed the threshold T, the flicker correction using inphase data preceding by a prescribed flicker cycle is not allowed. On the other hand, for example, if the amplitude of flicker becomes extremely large due to the types of illumination lamps, no large deviation occurs between the temporal average brightness average values Avv and the temporal average brightness value Av and thus the values of the averaged deviations D also become small. Accordingly, the values of the flags F representing a likelihood of the false correction of flicker become “0,” and the flicker correction using inphase data preceding by a prescribed flicker cycle is made.

In other words, with the comparison between the sizes of the averaged deviation ratios Dr and the threshold T, it is possible to accurately extract only areas whose brightness rapidly changes with time, i.e., the areas in which there is a high likelihood of the false correction of flicker.

In addition, according to the embodiment, if the false correction determination part 207 determines that there is a high likelihood of the false correction, the flicker correction using inphase data preceding by a prescribed flicker cycle is not allowed. Instead, the flicker gain selection part 211 goes back to the past by prescribed cycles to search for the flicker gain Fg in which the value of the flag F is “0,” i.e., the flicker gain Fg having a low likelihood of the false correction. If such a flicker gain Fg is found, the correction gain calculation part 212 calculates the flicker correction gain Fc using the found flicker correction gain Fg. Then, the gain correction part 213 makes the correction using the flicker correction gain Fc calculated by the correction gain calculation part 212.

If the rapid change of the brightness with time causing the false correction is ended in a short period of time, the flicker gain Fg in which the value of the flag F is “0” is found until the N-th data, i.e., the maximum length of the chronological data retained by each of the history retention parts is reached. In other words, if the rapid change of the brightness with time causing the false correction is ended in a short period of time, the flicker correction using the preceding flicker gain Fg having a low likelihood of the false correction is made in succession to the previous flicker correction.

If the rapid change of the brightness with time resulting in the false correction is continued without interruption, it is assumed that the flicker gain Fg in which the value of the flag F is “0” is not found even when the N-th data is reached. In this case, the flicker correction gain having a value of one time is set. In other words, the flicker correction itself is disabled.

Here, with the setting of an appropriate value as N for defining the maximum length of the chronological data of each of the history retention parts, it is possible to prevent the reference of old data highly likely to be different in waveform, amplitude, and phase from image data presently obtained.

In addition, according to the embodiment, instead of values obtained by dividing the in-screen average brightness values Bv by the temporal average brightness values Av, values obtained by dividing the in-screen average brightness values Bv by values obtained by subtracting the averaged deviations D from the temporal average brightness values Av are used as the flicker gains Fg. As the approximate values of the deviation components between the in-screen average brightness values Bv and the temporal average brightness values Av, values obtained by subtracting the averaged deviations D representing the deviation components between the temporal average brightness values Av and the temporal average brightness average values Avv become values used to reduce the deviation components between the in-screen average brightness values Bv and the temporal average brightness values Av. With the setting of values obtained by dividing the temporal average brightness values Av by such values as the flicker gains Fg, it is possible to reduce the frequency of the false correction of flicker. It has been experimentally confirmed that the estimated accuracy of the flicker gains Fg is improved particularly in areas in which the change of the brightness with time is relatively moderate.

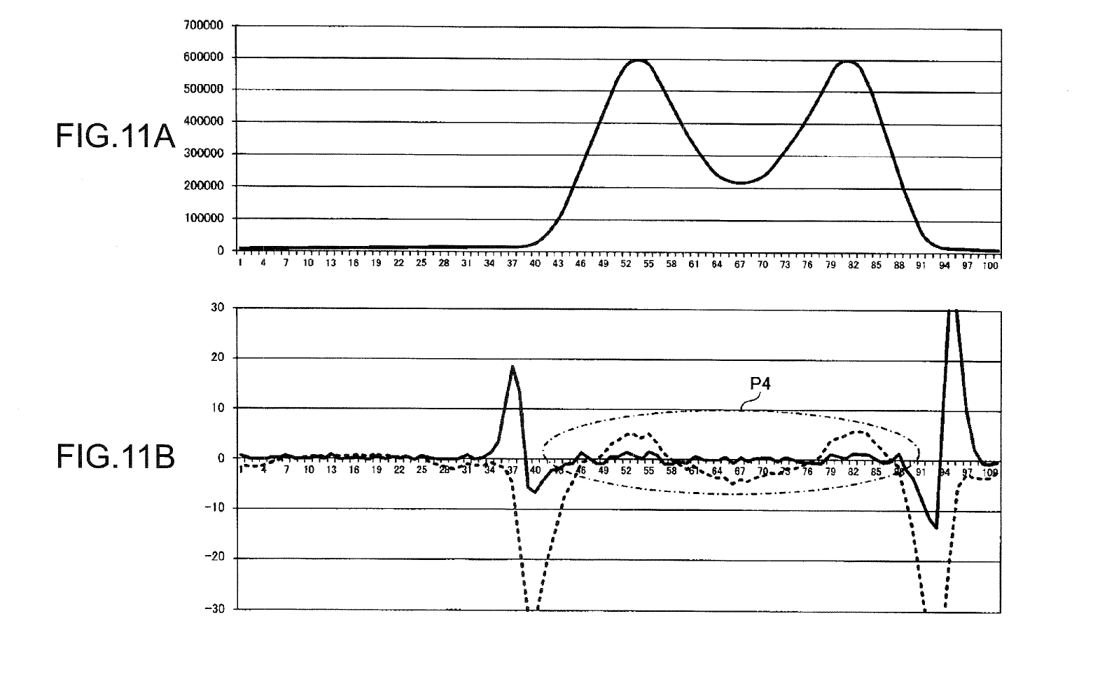

FIGS. 11A and 11B are graphs showing the contrast between the flicker gains Fg calculated according to the embodiment and flicker gains calculated according to the related art. FIG. 11A is a graph in which the in-screen average brightness values Bv are plotted on the temporal axis, and shows the brightness values on the vertical axis thereof and the temporal axis on the horizontal axis thereof. FIG. 11B is a graph in which the flicker gains Fg calculated according to the embodiment and the flicker gains calculated according to the related art are plotted on the temporal axis. In FIG. 11B, the flicker gains Fg calculated according to the embodiment are shown by a solid line, and the flicker gains calculated according to the related art are shown by a dashed line. FIG. 11B shows the sizes of the flicker gains on the vertical axis thereof and the temporal axis on the horizontal axis thereof.

As shown in FIG. 11A, original data from which the flicker gains are calculated has a waveform with peaks in the 52th frame or so and the 82th frame or so and valleys in the 66th frame or so. This data contains no flicker, and true flicker gains always have a value of one time. If the flicker gains are calculated based on such data according to the related art, the flicker gains having large values are calculated over the period between the 38th frame or so and the 95th frame or so as shown by the dashed line in FIG. 11B. The values of the flicker gains are particularly large in the period between the 35th frame or so and the 44th frame or so and the period between the 89th frame or so and the 96th frame or so. However, in the period encircled by a dashed line as a period P4 between such periods, the flicker gains having relatively large values are also calculated.

Conversely, the flicker gains Fg calculated according to the embodiment have values nearly equal to 0 in the period P4. In other words, according to the embodiment, it is possible to shorten the period in which the flicker gains Fg largely deviated from the actually calculated in-screen average brightness values Bv are calculated compared with the related art. That is, since it is possible to shorten the period in which the false correction of flicker is made, the image quality of shooting images is improved.

### 2. Various Modified Examples

The above embodiment includes a case in which surface flicker occurring in moving images shot using global shutter type imaging devices such as CCD image sensors is eliminated. However, it is also possible to eliminate line flicker occurring in moving images shot using rolling shutter type imaging devices such as CMOS image sensors. In this case, the flicker correction processing described above is performed for each image data acquired from each line of the CMOS devices, whereby flicker components contained in the image data acquired from the CMOS devices may be eliminated.

In addition, the above embodiment includes but not limited to a case in which the change of the inclination of the waveform of the temporal average brightness values Av is found by the calculation of the differences between the temporal average brightness average values Avv and the temporal average brightness values Av. Instead of the temporal average brightness average values Avv, values obtained by merely differentiating the temporal average brightness values Av may be used.

Moreover, according to the above embodiment, if there is a likelihood of the false correction of flicker, the correction with preceding data having a low likelihood of the false correction is made instead of the normal flicker correction using inphase data preceding by a prescribed flicker cycle as in the related art. However, other than the above, if there is a likelihood of the false correction of flicker, the normal flicker correction using inphase data preceding by a prescribed flicker cycle as in the related art may be merely disabled (i.e., the correction gain having a value of one time may be set).

Further, according to the embodiment, values obtained by dividing the in-screen average brightness values Bv by values obtained by subtracting the averaged deviations D from the temporal average brightness values Av are used as the flicker gains Fg instead of values obtained by dividing the in-screen average brightness values Bv by the temporal average brightness values Av. However, other than the above, values obtained by dividing the in-screen average brightness values Bv by the temporal average brightness values Av may be used as the flicker gains Fg.

Furthermore, the above embodiment is applied to the imaging apparatus 100 having the imaging device 100 but not limited thereto. Instead, the above embodiment may be applied to image data processing apparatuses that do not have an imaging device but capture image data output from external imaging apparatuses to perform image processing, or the like.

Furthermore, the above embodiment includes but not limited to a case in which the flicker gains Fg are calculated using the average brightness values of respective pixels (in-screen average brightness values Bv) constituting one screen region or one whole frame. Instead of the average brightness values of the respective pixels constituting one screen region or one whole frame, integrated pixel levels obtained by integrating the brightness of the respective pixels together may be used.

Note that the present disclosure may also employ the following configurations.

(1) An image data processing apparatus, including:

a brightness detection part configured to detect brightness of pixels in a prescribed range of each frame from image data acquired from an imaging device in which an image is shot at a prescribed imaging frequency;

a moving average calculation part configured to calculate a moving average of prescribed cycles of the brightness detected by the brightness detection part to calculate a temporal average brightness value as an average value of the prescribed cycles of the brightness;

a change quantity detection part configured to detect a change quantity of an inclination of a waveform constituted of the temporal average brightness value calculated by the moving average calculation part;

a false correction determination part configured to determine a likelihood of false correction to the image data based on information representing a change of the inclination detected by the change quantity detection part; and

a correction part configured to correct the image data acquired from the imaging device based on the determination result of the false correction determination part.

(2) The image data processing apparatus according to (1), in which

the change of the inclination detected by the change quantity detection part is represented by an averaged deviation as a difference between a temporal average brightness average value obtained by further calculating a moving average of the temporal average brightness value calculated by the moving average calculation part and the temporal average brightness value.

(3) The image data processing apparatus according to (1) or (2), in which

the false correction determination part is configured to determine that there is a high likelihood of the false correction if the averaged deviation is large.

(4) The image data processing apparatus according to any one of (1) to (3), further including:

a flicker gain calculation part configured to divide the brightness, which is detected by the brightness detection part, by a value obtained by subtracting the averaged deviation from the temporal average brightness value to calculate a flicker gain; and

a correction gain calculation part configured to calculate a correction gain using the flicker gain calculated by the flicker gain calculation part, in which

the correction part is configured to correct the image data acquired from the imaging device using the correction gain calculated by the correction gain calculation part.

(5) The image data processing apparatus according to (4), further including:

a flicker gain history retention part configured to store therein the flicker gain calculated by the flicker gain calculation part as chronological data; and

a flicker gain selection part configured to select a flicker gain used to calculate the correction gain from among the flicker gains stored in the flicker gain history retention part, in which

the flicker gain selection part is configured
to go back to a past to search for a flicker gain determined to have a low likelihood of the false correction if the flicker gain taken out from the flicker gain history retention part is determined by the false correction determination part to have a high likelihood of the false correction, and
to select, if the flicker gain determined to have the low likelihood of the false correction is detected, the detected flicker gain as the flicker gain used to calculate the correction gain.

(6) The image data processing apparatus according to (5), in which

the flicker gain selection part is configured to set the flicker gain at a value of one time if the flicker gain taken out from the flicker gain history retention part is determined by the false correction determination part to have the high likelihood of the false correction and the flicker gain determined to have the low likelihood of the false correction is not detected as a result of the search in the past.

(7) The image data processing apparatus according to (5) or (6), in which

a length of the past, for which the search is allowed when the flicker gain selection part searches for the flicker gain determined to have the low likelihood of the false correction, is set at a prescribed length in advance.

(8) The image data processing apparatus according to any one of (5) to (7), in which,

if the flicker gain taken out from the flicker gain history retention part is determined by the false correction determination part to have the low likelihood of the false correction, the flicker gain selection part is configured to select a flicker gain preceding by a prescribed flicker cycle in the past as the flicker gain used to calculate the correction gain.

(9) An imaging apparatus, including:

an imaging device configured to shoot an image at a prescribed imaging frequency;

a brightness detection part configured to detect brightness of pixels in a prescribed range of each frame from image data acquired from the imaging device;

a moving average calculation part configured to calculate a moving average of prescribed cycles of the brightness detected by the brightness detection part to calculate a temporal average brightness value as an average value of the prescribed cycles of the brightness;

a change quantity detection part configured to detect a change quantity of an inclination of a waveform constituted of the temporal average brightness value calculated by the moving average calculation part;

a false correction determination part configured to determine a likelihood of false correction to the image data based on information representing a change of the inclination detected by the change quantity detection part; and

a correction part configured to correct the image data acquired from the imaging device based on the determination result of the false correction determination part.

(10) An image data processing method, including:

detecting brightness of pixels in a prescribed range of each frame from image data acquired from an imaging device in which an image is shot at a prescribed imaging frequency;

calculating a moving average of prescribed cycles of the detected brightness to calculate a temporal average brightness value as an average value of the prescribed cycles of the brightness;

detecting a change of an inclination of a waveform constituted of the calculated temporal average brightness value;

determining a likelihood of false correction to the image data based on information representing the detected change of the inclination; and

correcting the image data acquired from the imaging device based on the determination result.

The present disclosure contains subject matter related to those disclosed in Japanese Priority Patent Application No. JP 2012-187409 filed in the Japan Patent Office on Aug. 28, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image data processing apparatus, comprising:
a brightness detection part configured to detect brightness of pixels in a prescribed range of each frame from image data acquired from an imaging device in which an image is shot at a prescribed imaging frequency;
a moving average calculation part configured to calculate a moving average of prescribed cycles of the brightness detected by the brightness detection part to calculate a temporal average brightness value as an average value of the prescribed cycles of the brightness;
a change quantity detection part configured to detect a change quantity of an inclination of a waveform constituted of the temporal average brightness value calculated by the moving average calculation part;
a false correction determination part configured to determine a likelihood of false correction to the image data based on information representing a change of the inclination detected by the change quantity detection part; and
a correction part configured to correct the image data acquired from the imaging device based on the determination result of the false correction determination part.

2. The image data processing apparatus according to claim 1, wherein
the change of the inclination detected by the change quantity detection part is represented by an averaged deviation as a difference between a temporal average brightness average value obtained by further calculating a moving average of the temporal average brightness value calculated by the moving average calculation part and the temporal average brightness value.

3. The image data processing apparatus according to claim 2, wherein
the false correction determination part is configured to determine that there is a high likelihood of the false correction if the averaged deviation is large.

4. The image data processing apparatus according to claim 3, further comprising:
a flicker gain calculation part configured to divide the brightness, which is detected by the brightness detection part, by a value obtained by subtracting the averaged deviation from the temporal average brightness value to calculate a flicker gain; and
a correction gain calculation part configured to calculate a correction gain using the flicker gain calculated by the flicker gain calculation part,
wherein
the correction part is configured to correct the image data acquired from the imaging device using the correction gain calculated by the correction gain calculation part.

5. The image data processing apparatus according to claim 4, further comprising:
a flicker gain history retention part configured to store therein the flicker gain calculated by the flicker gain calculation part as chronological data; and
a flicker gain selection part configured to select a flicker gain used to calculate the correction gain from among the flicker gains stored in the flicker gain history retention part, wherein
the flicker gain selection part is configured
to go back to a past to search for a flicker gain determined to have a low likelihood of the false correction if the flicker gain taken out from the flicker gain history retention part is determined by the false correction determination part to have a high likelihood of the false correction, and
to select, if the flicker gain determined to have the low likelihood of the false correction is detected, the detected flicker gain as the flicker gain used to calculate the correction gain.

6. The image data processing apparatus according to claim 5, wherein
the flicker gain selection part is configured to set the flicker gain at a value of one time if the flicker gain taken out from the flicker gain history retention part is determined by the false correction determination part to have the high likelihood of the false correction and the flicker gain determined to have the low likelihood of the false correction is not detected as a result of the search in the past.

7. The image data processing apparatus according to claim 5, wherein
a length of the past, for which the search is allowed when the flicker gain selection part searches for the flicker gain determined to have the low likelihood of the false correction, is set at a prescribed length in advance.

8. The image data processing apparatus according to claim 5, wherein,
if the flicker gain taken out from the flicker gain history retention part is determined by the false correction determination part to have the low likelihood of the false correction, the flicker gain selection part is configured to select a flicker gain preceding by a prescribed flicker cycle in the past as the flicker gain used to calculate the correction gain.

9. An imaging apparatus, comprising:
an imaging device configured to shoot an image at a prescribed imaging frequency;
a brightness detection part configured to detect brightness of pixels in a prescribed range of each frame from image data acquired from the imaging device;
a moving average calculation part configured to calculate a moving average of prescribed cycles of the brightness detected by the brightness detection part to calculate a temporal average brightness value as an average value of the prescribed cycles of the brightness;
a change quantity detection part configured to detect a change quantity of an inclination of a waveform constituted of the temporal average brightness value calculated by the moving average calculation part;
a false correction determination part configured to determine a likelihood of false correction to the image data based on information representing a change of the inclination detected by the change quantity detection part; and
a correction part configured to correct the image data acquired from the imaging device based on the determination result of the false correction determination part.

10. An image data processing method, comprising:
detecting brightness of pixels in a prescribed range of each frame from image data acquired from an imaging device in which an image is shot at a prescribed imaging frequency;
calculating a moving average of prescribed cycles of the detected brightness to calculate a temporal average brightness value as an average value of the prescribed cycles of the brightness;
detecting a change of an inclination of a waveform constituted of the calculated temporal average brightness value;
determining a likelihood of false correction to the image data based on information representing the detected change of the inclination; and
correcting the image data acquired from the imaging device based on the determination result.
